(19) United States
(12) Patent Application Publication
(10) Pub. No.: US 2004/0003240 A1
(43) Pub. Date: Jan. 1, 2004

(54) Electronic book encryption and copy prevention method

(75) Inventors: Cheng-Shing Lai, Taipei Hsieng (TW); Ai-Min Yu, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsieng (TW)

(21) Appl. No.: 10/180,345

(22) Filed: Jun. 27, 2002

(51) Int. Cl. H04L 9/00

(52) U.S. Cl. 713/165

(57) ABSTRACT

The invention is to provide an electronic book encryption and copy prevention method in which after an electronic device downloads a said electronic book from a wireless communications network, the said electronic book is decrypted by executing a corresponding decryption program and code key, following which reading is enabled; as a result, when reading the correct data content of an electronic book enabled by the method of the invention herein, not only is its corresponding decryption program and specific code key required, but the said decryption program and specific code key directly responds to the data output of the said electronic book.

### BACKGROUND OF THE INVENTION

1) Field of the Invention

The invention herein relates to an electronic book encryption and copy prevention method.

2) Description of the Prior Art

In the so-called E-age of today, the public demand for information exchange has become larger and larger due to the rapid dissemination of information. As a result, numerous portable electronic devices such as personal digital assistants (hereafter referred to as PDA) and mobile telephones, etc. have become widely utilized in all fields and, furthermore, indispensable to the lifestyle of many people.

Generally speaking, electronic books on networks are freely available for reading. After downloading them, users only have to find a reading device that supports the format of the said electronic book to read and, furthermore, willfully copy and distribute them. The said situation is especially problematic with PDAs and other handheld equipment capable of downloading information from wireless networks and precautions should taken.

Since electronic book commercial distributors and copyright holders currently do not have a particular method of protecting themselves against the unintended usage and even pirating of their electronic books. Therefore, the said electronic book commercial distributors and copyright holders await a solution that will remedy this serious problem.

### SUMMARY OF THE INVENTION

In view of the shortcomings such as the said free availability of electronic books on networks and the lack of a particular protective method for electronic book commercial distributors and copyright holders that protects them against the unintended usage, pirating, willful copying and distribution of their electronic books as well as other related activities, the inventor of the invention herein research and developed the invention herein based on many years of professional experience and study, with the present invention providing an electronic book encryption and copy prevention method that solves the said conventional shortcomings.

An objective of the invention herein is to provide an electronic book encryption and copy prevention method in which after an electronic device downloads a said electronic book from a wireless communications network, the said electronic book is decrypted by executing a corresponding decryption program and code key, following which reading is enabled; as a result, when reading the correct data content of an electronic book enabled by the method of the invention herein, not only is its corresponding decryption program and specific code key required, but the said decryption program and specific code key directly responds to the data output of the said electronic book, thereby effectively and significantly increasing electronic book commercial distributor and copyright holder benefits.

Yet another objective of the invention herein is to provide an electronic book encryption and copy prevention method in which since downloaded electronic books are stored on electronic devices and thus to prevent the unauthorized copying and transferring of electronic book content between various said electronic devices by users, the invention herein places a counter in the said electronic book data structure at a position that does not affect any data structure; the said counter contains a preset value and before electronic book downloading and the said preset value is established according to the restrictions or subscription fee of the user; when the preset value in the said counter is reduced to zero, the electronic book data refuses further copying to prevent unlimited user copying and distribution, thereby protecting the interests of electronic book commercial distributors and copyright holders.

### BRIEF DESCRIPTION OF THE DRAWINGS

FIG. 1 is a flowchart of the code key decryption procedures of the invention herein.

FIG. 2 is a flowchart of the copy prevention procedures of the invention herein.

### DETAILED DESCRIPTION OF THE INVENTION

There are currently many portable electronic devices such as PDAs and mobile telephones, etc. that all support the Wireless Application Protocol (WAP) and, as a result, the said electronic devices are now capable of directly accessing network resources over wireless communications networks. Since all electronic books have commercial distributor and copyright holder, but there is no particular protection available to safeguard copyrighted electronic books from being directly accessed, utilized in unintended ways, and even pirated over networks, those wanting to read electronic books on networks only have to download them and then find a reading device that supports the format of the said electronic book, which not only allows reading but, furthermore, willful copying and distribution. As such, electronic book commercial distribution and copyright losses are of considerable immensity, while copyright infringement issues continue to occur. Therefore, a process is required that provides for the encryption and copy prevention of electronic books on networks.

In response to development trends, the invention herein consists of the specific code key encryption of electronic book data content such that after an electronic device downloads a said electronic book from a wireless communications network, the said electronic book is decrypted by executing a corresponding decryption program and code key, following which reading is enabled. Furthermore, a copy prevention counter is included in the data content of the said electronic book, the said counter imposing a set limit as to the utilization of the said electronic book by the user such that when the said electronic book is copied, the copying of the said electronic book commences after the recognition and processing of the said counter; as such, the electronic book encryption and copy prevention process of the invention herein effectively prevents the willful reading of electronic books and, furthermore, unrestricted copying and distribution, thereby significantly increasing commercial distributor and copyright holder benefits.

In the invention herein, the key code encryption in the data content of the said electronic book consists of two parts; the first part of the key code encryption is permanent and utilized to directly convey/indicate the company/unit that produced the electronic book; for example, the key word “Inventec” directly conveys/indicates that an electronic book was produced by the said “Inventec”, the company/unit.

The other part of the key code encryption is disposed in a certain area of the said electronic book data content and, furthermore, the data content value of the other part differs from the data content of any electronic book; when an electronic book is downloaded from a wireless communications network to a said electronic device, the said data content value is automatically random generated, with this part of the key code encryption issued by the publisher of the said electronic book to indicate the publication time of the said electronic book. Since frames serve as units of data sending during network transfers, frame differentiation processing is required before data is sent to an electronic device and when the reception of all frames is finished, a complete electronic book document is compiled; an information header structure is permanently situated in the said document and the random data content value is acquired in a certain position of the said information header.

As such, the said permanent code key encryption (such as “Inventec”) and the said random data content value code key encryption are combined such that they become a code key that opens the said corresponding electronic book data.

In the invention herein, after an electronic device downloads an electronic book from a wireless communications network, decryption is performed by its corresponding electronic book data decryption program and code key, following which reading is enabled; as the said decryption process is executed during reading and, furthermore, the electronic book original text is unchanged and without its corresponding decryption program and code key, although the said electronic book data structure is not affected, the accessed results appear as an block of jumbled code. As a result, when reading the correct data content of an electronic book enabled by the method of the invention herein, not only is its corresponding decryption program and specific code key required, but the said decryption program and specific code key directly responds to the data output of the said electronic book, thereby effectively and significantly increasing commercial distributor and copyright holder benefits.

In the invention herein, since downloaded electronic books are stored on electronic devices and thus to prevent the unauthorized copying and transferring of electronic book content between various said electronic devices by users, the invention herein places a counter in the said electronic book data structure at a position that does not affect any data structure; the said counter contains a preset value and before electronic book downloading and the said preset value is established according to the restrictions or subscription fee of the user; for example, if the user purchases 100 copying units, the preset value in the said electronic book counter is 100 copying units, and so on.

In the invention herein, when the user transfers electronic book data between various said electronic devices, each time the said electronic book data is copied, the said preset value is reduced by one instance and, furthermore, following the said reduction, the preset value is shown in the electronic book data emblem area to enable the user to understand the current status of the said preset value and after the electronic book data is copied, the said value is no longer displayed. When the preset value in the said counter is reduced to zero, the electronic book data refuses further copying to prevent unlimited user copying and distribution, thereby protecting the interests of electronic book commercial distributors and copyright holders.

Furthermore, if a said electronic book commercial distributor does not require the said protective measures, the corresponding information can be included in the said electronic book data, at which time the reading device determines whether it is necessary to perform decryption based on the said information. Moreover, an unauthorized reading device is incapable of accurately reading encrypted electronic book data content.

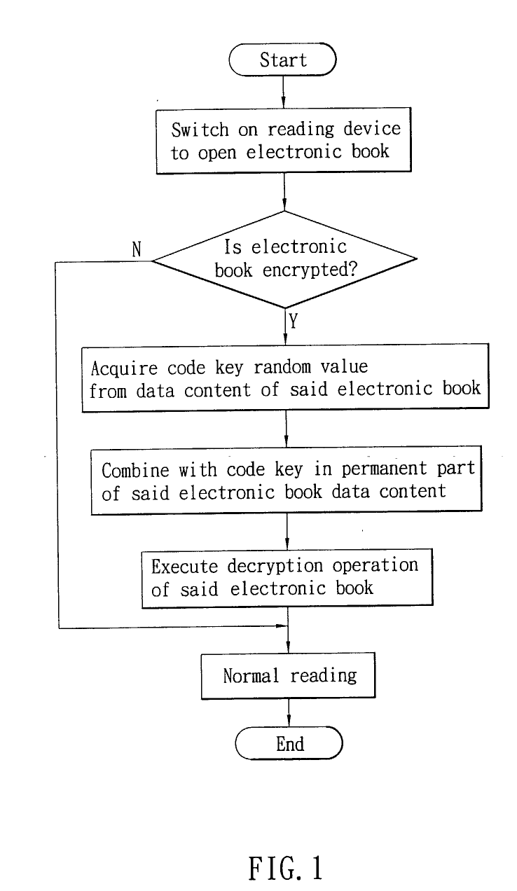

Referring to FIG. 1, after an electronic device downloads an electronic book from a wireless communications network, the key code decryption processing of the said electronic book is executed according to the following procedures:

(1) First, the said electronic book is opened by switching on a reading device.

(2) It is determined whether the said electronic book has encrypted information; if encrypted information is present, the random data content value in the said electronic book data content is acquired by its corresponding decryption program and code key.

(3) Meanwhile, the permanent part (for example, “Inventec”) of its code key in the said electronic book data content is combined to form a whole code key.

(4) Next, the said whole code key is coordinated with the said decryption program to execute the decryption the encrypted part of the said electronic book data and following decryption, normal reading operation is conducted.

(5) When it is determined that the said electronic book has no encrypted information, the reading operation of the said electronic book directly occurs (indicating that the said electronic book is not encrypted).

As such, an encrypted electronic book is effortlessly decrypted to enable normal reading operation.

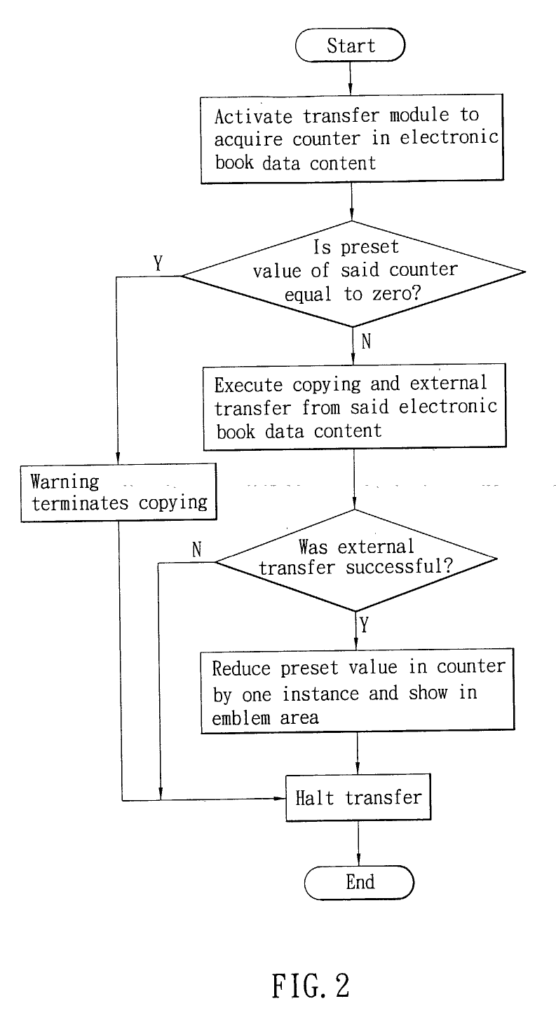

In the invention herein, referring to FIG. 2, after the said electronic book is effortlessly decrypted, the processing that provides for the prevention of the willful copying of the said electronic book is executed according to the following procedures:

(1) First, the counter in the said electronic book data content is acquired by activating a transfer module to prepare for the transfer and copying of the said electronic book.

(2) It is determined whether the preset value of the said counter is equal to zero; if information does not indicate zero, then the said electronic book data is acquired, copied, and externally transferred.

(3) Next, it is determined whether the external transfer was successful; if the transfer was a success, then the preset value of the counter in the acquired said electronic book data is reduced by one instance and, furthermore, following the said reduction, the preset value is shown in the emblem area, with the said value no longer displayed after the electronic book data is copied; at the same time, transfer is halted, thereby concluding the said operation.

(4) When it is determined based on information that the preset value of the said counter is zero, then a warning terminates copying, transfer is halted, and the operation is concluded.

(5) When it is determined that the said external transfer was unsuccessful, then transfer is halted and the operation is concluded.

As such, unlimited user copying of data is prevented, thereby protecting the interests of electronic book commercial distributors and copyright holders.

1. An electronic book encryption and copy prevention method consisting of the specific code key encryption of electronic book data content such that after an electronic device downloads a said electronic book from a wireless communications network, the said electronic book is decrypted by executing a corresponding decryption program and code key, following which reading is enabled; furthermore, a copy prevention counter is included in the data content of the said electronic book, the said counter imposing a set limit as to the utilization of the said electronic book by the user such that when the said electronic book is copied, the copying of the said electronic book commences after the recognition and processing of the said counter.

2. An electronic book encryption and copy prevention method as claimed in claim 1 in which the said key code encryption consists of two parts; the first part of the key code encryption is permanent and utilized to directly convey/indicate the company/unit that produced the electronic book; the other part of the key code encryption is disposed in a certain area of the said electronic book data content and differs from the data content of any electronic book; furthermore, when an electronic book is downloaded from a wireless communications network to a said electronic device, a data content value is automatically random generated, with the said permanent code key encryption and the said random data content value code key encryption combined such that they become a code key that opens the said corresponding electronic book data.

3. An electronic book encryption and copy prevention method as claimed in claim 1 in which the said counter is placed in the said electronic book data structure at a position that does not affect any data structure; the said counter contains a preset value and before electronic book downloading, the said preset value is established according to the restrictions or subscription fee of the user.

4. An electronic book encryption and copy prevention method as claimed in claim 2 in which after the said electronic device downloads an electronic book from a wireless communications network, the key code decryption processing of the said electronic book is executed according to the following procedures;
opening the said electronic book through switching on a reading device;
determining whether the said electronic book has encrypted information; if encrypted information is present, acquiring the random data content value in the said electronic book data content by its corresponding decryption program and code key;
combining the permanent part of its code key in the said electronic book data content to form a whole code key;
next, coordinating the said whole code key with the said decryption program to execute the decryption with respect to the encrypted part of the said electronic book data.

5. An electronic book encryption and copy prevention method as claimed in claim 4 in which when it is determined that the said electronic book has no encrypted information, the reading operation of the said electronic book directly occurs.

6. An electronic book encryption and copy prevention method as claimed in claim 4 in which after the said electronic book is effortlessly decrypted, the processing that provides for the prevention of the willful copying of the said electronic book is executed according to the following procedures;
first, acquiring the counter in the said electronic book data content by activating a transfer module to prepare for the transfer and copying of the said electronic book;
determining whether the preset value of the said counter is equal to zero; if information does not indicate zero, then acquiring, copying, and externally transferring the said electronic book data;
next, determining whether the external transfer was successful; if the transfer was a success, then reducing the preset value of the counter in the acquired said electronic book data by one instance and, furthermore, following the said reduction, showing the preset value in the emblem area, with the said value no longer displayed after the electronic book data is copied; at the same time, halting the said transfer and concluding the said operation.

7. An electronic book encryption and copy prevention method as claimed in claim 6 in which when it is determined based on information that the preset value of the said counter is zero, then a warning terminates copying, transfer is halted, and the operation is concluded.

8. An electronic book encryption and copy prevention method as claimed in claim 6 in which when it is determined that the said external transfer was unsuccessful, then transfer is halted and the operation is concluded.

9. An electronic book encryption and copy prevention method as claimed in claim 1 in which the said electronic device can be a mobile telephone.

10. An electronic book encryption and copy prevention method as claimed in claim 1 in which the said electronic device can be a PDA.
